(19) United States
(12) Patent Application Publication
(10) Pub. No.: US 2018/0216626 A1
(43) Pub. Date: Aug. 2, 2018

(54) ALUMINUM BRAZING OF HOLLOW TITANIUM FAN BLADES

(71) Applicant: United Technologies Corporation, Farmington, CT (US)

(72) Inventors: Daniel A. Bales, Avon, CT (US); Thomas J. Watson, South Windsor, CT (US)

(21) Appl. No.: 15/928,246

(22) Filed: Mar. 22, 2018

Related U.S. Application Data
(63) Continuation of application No. 13/625,956, filed on Sep. 25, 2012.

(51) Int. Cl. F04D 29/18; F04D 29/32; F01D 5/14; F04D 29/02; F04D 29/20; B23K 1/00; B23P 15/04

(52) U.S. Cl. CPC F04D 29/18; F04D 29/324; F01D 5/147; F04D 29/023; F04D 29/20; F05D 2300/174; B23P 15/04; F05D 2220/36; F05D 2230/237; F05D 2300/133; F05D 2300/173; B23K 1/0018

(57) ABSTRACT

A fan blade includes first and second titanium alloy portions that are secured to one another with an aluminum alloy braze that contains manganese. The first titanium alloy portion includes ribs, a root, and at least a portion of an exterior airfoil contour of the fan blade. The second titanium alloy portion includes another portion of the exterior airfoil contour. The ribs are secured to the second titanium alloy portion with the aluminum alloy braze. The first titanium alloy portion includes a tip, and leading and trailing edges. The second titanium alloy portion has a perimeter that is arranged inboard of the root, the tip and the leading and trailing edges.

### CROSS-REFERENCE TO RELATED APPLICATIONS

This disclosure is a continuation of U.S. patent application Ser. No. 13/625,956 filed Sep. 25, 2012.

### BACKGROUND

This disclosure relates to hollow fan blades and a method of brazing the same.

Titanium-based alloys are widely used for structural applications in the aerospace industry. These alloys provide good fatigue properties, erosion benefits relative to aluminum alloys, and are light weight compared to steel, stainless steels, and nickel alloys. While significant weight savings can be achieved with solid titanium components, even greater weight savings can be achieved using hollow structures.

It is difficult to create a complicated airfoil shape, especially a hollow fan blade (HFB). Hollow titanium fan blades are typically produced by diffusion bonding two machined cavity-containing plates on the neutral axis, hot forming and inflating the bonded assembly to achieve its final shape within complex dies, and finally post-thermal processing the blade's surface to remove any surface contamination. Much of the part cost is incurred by the complex bonding and forming process.

Common practice for joining hollow titanium structures is by brazing with titanium-nickel-copper alloys or by diffusion bonding. Brazing titanium with aluminum has been used for decades, but requires a narrow window of time and temperature. This stems from the fact that aluminum and titanium can form brittle intermetallic phases at the joint interface, if line and temperature are not properly controlled.

### SUMMARY

In one exemplary embodiment, a fan blade includes first and second titanium alloy portions that are secured to one another with an aluminum alloy braze that contains manganese. The first titanium alloy portion includes ribs, a root, and at least a portion of an exterior airfoil contour of the fan blade. The second titanium alloy portion includes another portion of the exterior airfoil contour. The ribs are secured to the second titanium alloy portion with the aluminum alloy braze. The first titanium alloy portion includes a tip, and leading and trailing edges. The second titanium alloy portion has a perimeter that is arranged inboard of the root, the tip and the leading and trailing edges.

In a further embodiment of any of the above, the first titanium alloy portion is provided by a forging of one of Ti-6-4 and Ti-6-2-4-2.

In a further embodiment of any of the above, the ribs are machined ribs that include undercuts that have an arcuate shape such that a dimension through a brazed surface between the first and second titanium alloy portions is greater than a parallel section through its supporting rib of the ribs.

In a further embodiment of any of the above, the second titanium alloy portion is a hot-formed sheet that provides a cover that has a uniform cross-sectional thickness and a generally rectangular shape.

In a further embodiment of any of the above, the ribs form five or more channels in a cross-section that extend through the leading and trailing edges.

In a further embodiment of any of the above, the cover provides one side of the airfoil.

In a further embodiment of any of the above, the first titanium alloy portion includes opposing first and second edges that define the leading and trailing edges.

In another exemplary embodiment, A method of manufacturing a fan blade includes providing a first titanium alloy portion that have ribs that provide channels. The ribs have mating surfaces. A second titanium alloy portion is pressed to produce a cover that provides a side of the airfoil. An aluminum alloy braze is applied to at least one of the first and second titanium alloy portions. The mating surfaces has the aluminum alloy braze and the channels are free from the aluminum alloy braze. The fan blade is heated in an inert gas environment to melt the aluminum alloy braze and join the cover to the ribs to provide a fan blade with an airfoil exterior contour.

In a further embodiment of any of the above, the method includes the step of pickling the cover.

In a further embodiment of any of the above, the method includes the step of applying the aluminum alloy braze after pickling the cover.

In a further embodiment of any of the above, the method includes the step of bagging the first and second titanium alloy portions prior to performing the heating step.

In a further embodiment of any of the above, the method includes of purging the bag prior to the heating step.

In a further embodiment of any of the above, the method includes of pulling a vacuum on the bag during the heating step.

In a further embodiment of any of the above, the first titanium alloy portion provides a root, a tip and leading and trailing edges of the airfoil exterior contour. The second titanium alloy portion has a perimeter that is arranged inboard of the root, the tip and the leading and trailing edges.

In a further embodiment of any of the above, the aluminum alloy braze contains at least 92% aluminum.

In a further embodiment of any of the above, the mate faces are arcuate in shape.

### BRIEF DESCRIPTION OF THE DRAWINGS

The disclosure can be further understood by reference to the following detailed description when considered in connection with the accompanying drawings wherein:

FIG. 1 is a perspective view of an example brazed titanium fan blade.

FIG. 2A is a cross-sectional view of the fan blade shown in FIG. 1 taken along line 2A-2A.

FIG. 2B is an exploded enlarged view of a portion of the fan blade shown in FIG. 2A.

FIG. 3 is a flow chart depicting an example manufacturing method for the fan blade.

FIG. 4 schematically depicts the brazing process.

### DETAILED DESCRIPTION

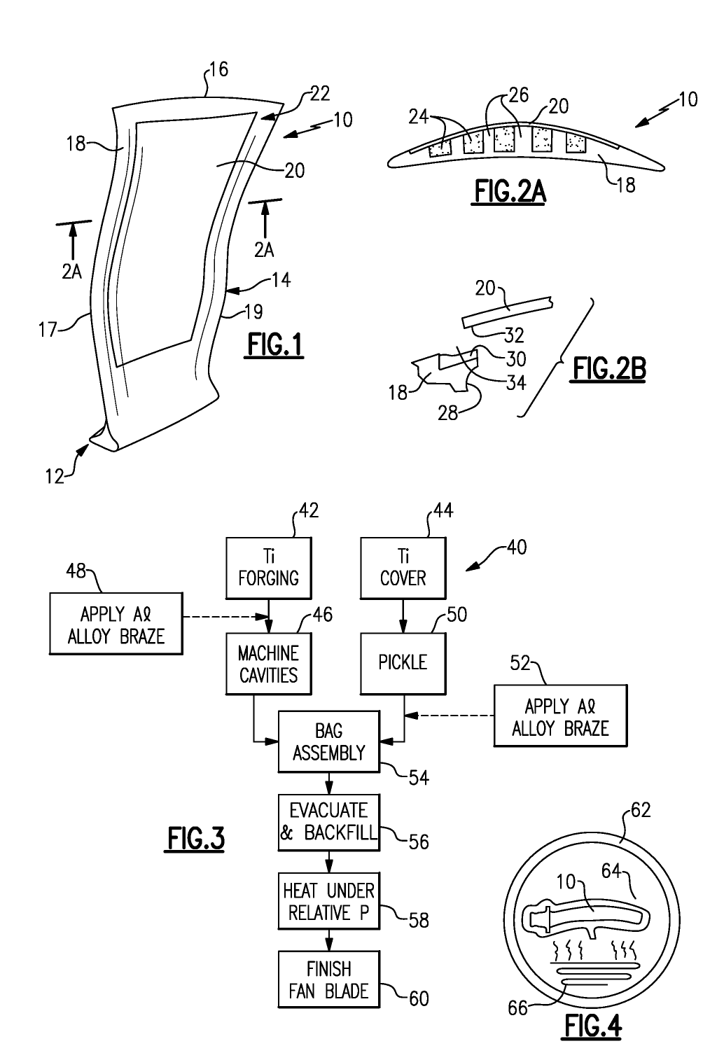

A fan blade 10 is schematically depicted in FIGS. 1 and 2. The fan blade 10 includes a root 12 supporting an airfoil 14 that extends to a tip 16. First and second titanium portions 18, 20 are brazed to one another to provide an exterior contour 22 of the fan blade 10.

In the example, the first titanium portion 18 is provided by a forged blank that is machined to remove material 24. Ribs 26 are provided that have undercuts 28 with an arcuate shape and within the interior of the first titanium portion 18 to reduce weight while providing fan blade structural integrity, ensuring blade fatigue life, and supporting the airfoil cover 20. The first titanium portion 18 provides the root 12 and one side of the airfoil 14 along with the tip 16. The first portion 18 also provides first and second edges that define fan blade leading and trailing edges 17, 19.

The second titanium portion 20 provides a cover that is secured over the interior of the first titanium portion 18 by a braze 34. A titanium cover would be used for its thermal expansion match with the titanium forging, its superior corrosion resistance relative to aluminum, its improved stiffness relative to aluminum, its improved erosion resistance relative to aluminum, and its improved foreign object debris/impact resistance relative to aluminum.

The braze 34 is provided on one or both of the first and second mating surfaces 30, 32, which are respectively provided by the first and second titanium portions 18, 20. In one example, the braze 34 is an aluminum alloy, such as Al-Cu-Mn, having less than 3 wt % copper and less than 5 wt % manganese and having a solidus-liquidus range within 1175° F.-1225° F. The aluminum or aluminum alloy chosen for brazing would be pre-placed onto either the titanium cover or the titanium forging as a photo etched pre-form or cathodic arc deposited directly onto the titanium cover or the titanium forging. In one example, the entire surface of the side of the cover being brazed or the side of the forging being brazed would be cathodic arc deposited prior to machining the forging or prior to selective etching the titanium cover to only provide braze material at areas being joined.

A method 40 of forming the fan blade 10 is schematically illustrated at 40. A titanium forging (first titanium portion 18) is provided, as indicated by block 42. The proposed method of construction uses a near net shape titanium forging with certified mechanical properties.

The titanium forging is machined, as indicated at block 46, to provide structure similar to that shown in FIGS. 1 and 2, for example. The fan blade design may be tailored such that no internal foam inserts would be needed, although inserts may be used if desired. Prior to machining (in instances where no metallic foam inserts are used), an aluminum alloy braze may be applied, as indicated at block 48. Thus, the braze will be provided only on the raised surfaces, which provides the first mating surface 30, subsequent to machining.

A titanium cover (second titanium portion 20) may be provided, as indicated at block 44. The titanium cover may be hot formed at processing conditions that ensure maintaining its certified mechanical properties, while achieving the desired shape for bonding. Alternatively, or in addition to, an aluminum alloy braze may be applied, as indicated at block 52, to the titanium cover subsequent to pickling, as indicated at block 50. Pickling provides a contaminant-free surface on the cover.

The cover is arranged over the titanium forging such that the first and second mating surfaces 30, 32 engage one another. The assembled fan blade 10 is inserted into a bag 64 (FIG. 4), as indicated at block 54. The bag is a metallic bag, which may be constructed from a stainless steel or a nickel alloy foil, for example, that can be sealed.

In one example, the sealed bagged fan blade is loaded into a vacuum compression brazing furnace 62 having a heating element 66, which is shown in FIG. 4. Oxygen and nitrogen within the bag are evacuated and the bag is backfilled with argon, as indicated at block 56. Evacuation and backfilling may be repeated multiple times to reduce the oxygen and nitrogen to an acceptable concentration within the bag and within the fan blade's internal cavities. Following the final evacuation, a negative atmosphere is maintained within the sealed bag. The magnitude of the bag's internal negative pressure is such that any positive pressure or vacuum external to the bag always provides force upon the titanium cover 20 and the machined fan blade 10 within the bag 64, throughout all subsequent heating, brazing and cooling.

Brazing could occur within a vacuum furnace capable of applying a positive pressure of argon, within an argon retort, within a furnace capable of maintaining a hard vacuum or within a vacuum furnace capable of maintaining a partial pressure of argon. In the first example, vacuum compression brazing furnace 62 is capable of applying a positive pressure of argon to the bagged fan blade 10 during heating to melt the aluminum alloy braze material and during subsequent cooling. If brazing within an argon retort, such an environment would be free of both oxygen and nitrogen to the extent acceptable for producing a finished product within the design criteria but meeting or bettering specified surface contamination requirements. If in a standard vacuum furnace, brazing would be accomplished by heating parts in a retort or other line-of-sight shielding at 5×10-4 ton or lower pressure within a temperature range of 1225° F. to 1290° F. Regardless of the furnace choice, time between 1175° F. on heating and 1175° F. on cooling would be controlled to produce a braze microstructure that conforms to metallurgical standards established by material characterization testing and fan blade component testing. Such standards would control amount of particulate, titanium aluminide, and eutectic intermetallic structure within the braze. Because the aluminum brazing temperature is lower than annealing temperatures used for titanium alloys such as Ti-6-4 and Ti-6-2-4-2, certified mechanical properties of the fan blade cover 20 and the fan blade forging 18 previously created during prior plate/sheet rolling, fan blade forging, and associated follow-on heat treatment will be maintained throughout all aluminum brazing thermal processing. The fan blade is then finished, if necessary, as indicated at block 60.

Although an example embodiment has been disclosed, a worker of ordinary skill in this art would recognize that certain modifications would come within the scope of the claims. For that reason, the following claims should be studied to determine their true scope and content.

What is claimed is:

1. A fan blade comprising:
first and second titanium alloy portions are secured to one another with an aluminum alloy braze that contains manganese, wherein the first titanium alloy portion includes ribs, a root, and at least a portion of an exterior airfoil contour of the fan blade, the second titanium alloy portion includes another portion of the exterior airfoil contour, and the ribs are secured to the second titanium alloy portion with the aluminum alloy braze, wherein the first titanium alloy portion includes a tip, and leading and trailing edges, the second titanium alloy portion having a perimeter that is arranged inboard of the root, the tip and the leading and trailing edges.

2. The fan blade according to claim 1, wherein the first titanium alloy portion is provided by a forging of one of Ti-6-4 and Ti-6-2-4-2.

3. The fan blade according to claim 1, wherein the ribs are machined ribs that include undercuts having an arcuate shape such that a dimension through a brazed surface between the first and second titanium alloy portions is greater than a parallel section through its supporting rib of the ribs.

4. The fan blade according to claim 1, wherein the second titanium alloy portion is a hot-formed sheet providing a cover having a uniform cross-sectional thickness and a generally rectangular shape.

5. The fan blade according to claim 1, wherein the ribs form five or more channels in a cross-section extending through the leading and trailing edges.

6. The fan blade according to claim 5, wherein the cover provides one side of the airfoil.

7. The fan blade according to claim 6, wherein the first titanium alloy portion includes opposing first and second edges that define the leading and trailing edges.

8. A method of manufacturing a fan blade comprising:
providing a first titanium alloy portion having ribs providing channels, the ribs having mating surfaces;
pressing a second titanium alloy portion to produce a cover providing a side of the airfoil;
applying an aluminum alloy braze to at least one of the first and second titanium alloy portions, wherein the mating surfaces has the aluminum alloy braze and the channels are free from the aluminum alloy braze; and
heating the fan blade in an inert gas environment to melt the aluminum alloy braze and join the cover to the ribs to provide a fan blade with an airfoil exterior contour.

9. The method according to claim 8, comprising the step of pickling the cover.

10. The method according to claim 9, comprising the step of applying the aluminum alloy braze after pickling the cover.

11. The method according to claim 10, comprising the step of bagging the first and second titanium alloy portions prior to performing the heating step.

12. The method according to claim 11, comprising the step of purging the bag prior to the heating step.

13. The method according to claim 12, comprising the step of pulling a vacuum on the bag during the heating step.

14. The method according to claim 8, wherein the first titanium alloy portion provides a root, a tip and leading and trailing edges of the airfoil exterior contour, wherein the second titanium alloy portion has a perimeter that is arranged inboard of the root, the tip and the leading and trailing edges.

15. The method according to claim 8, wherein the aluminum alloy braze contains at least 92% aluminum.

16. The method according to claim 8, wherein the mate faces are arcuate in shape.
